(19) United States
(12) Patent Application Publication
(10) Pub. No.: US 2013/0059202 A1
(43) Pub. Date: Mar. 7, 2013

(54) POLYMER-COATED ACTIVE MATERIAL AND LITHIUM SECONDARY BATTERY USING THE SAME

(71) Applicants: Etsuko Nishimura, Hitachiota (JP); Katsunori Nishimura, Hitachiota (JP); Akihide Tanaka, Hitachinaka (JP); Makoto Morishima, Hitachinaka (JP)

(72) Inventors: Etsuko Nishimura, Hitachiota (JP); Katsunori Nishimura, Hitachiota (JP); Akihide Tanaka, Hitachinaka (JP); Makoto Morishima, Hitachinaka (JP)

(73) Assignee: HITACHI, LTD., Tokyo (JP)

(21) Appl. No.: 13/591,606

(22) Filed: Aug. 22, 2012

(30) Foreign Application Priority Data
Sep. 7, 2011 (JP) 2011-194504

(51) Int. Cl. H01M 4/60; H01M 4/88

(52) U.S. Cl. 429/213; 252/182.1

(57) ABSTRACT

Provided is a lithium ion secondary battery including a cathode that is capable of occluding and emitting lithium ions, and an anode that is capable of occluding and emitting the lithium ions. A polymer compound containing a polyether portion and a carboxylic acid bonding portion is bonded to an active material as shown with a structure I, a structure II, a structure III, and a structure IV.

### BACKGROUND OF THE INVENTION

1. Field of the Invention

The present invention relates to a polymer coated active material and a lithium secondary battery using the same.

2. Background Art

A secondary battery that is represented by a lithium ion battery has high specific energy density, and thus has attracted attention as a battery for an electric vehicle or a battery for energy storage. Particularly, examples of the electric vehicle include a zero emission electric automobile in which an engine is not mounted, a hybrid electric vehicle in which both an engine and a secondary battery are mounted, or a plug-in hybrid electric vehicle that is directly charged from electricity delivered from an electrical grid. In addition, the lithium ion battery is also expected as a use for a stationary electric power storage system that stores power and supplies power at an emergency time when the electrical grid is blocked.

In regard to these various uses, a large output and excellent durability are required for the lithium ion battery. That is, in regard to a power source for automobile use, an output performance of 10 C-rate or more is required at the time of operation stoppage, and in regard to a stationary power source for power backup during a power failure or load leveling, an output performance of 1 to 2 C-rate is also required. Here, 1 C-rate represents a charge or discharge rate when a rated capacity of the lithium ion battery is used up in one hour. 2 C-rate is a charge or discharge rate at a current of five times the current at 1 C-rate, and 10 C-rate is a charge or discharge rate at a large current corresponding to a current of ten times the current at 1 C-rate. In regard to the durability, a lifetime of 6,000 cycles or more, and 200,000 km or more in terms of a travel distance are required.

When a current value of the charge or discharge of the lithium ion battery is increased, a current per unit area (that is, a current density) of an electrode increases, such that uneven heat generation occurs inside the battery, and thus a variation in an amount of occlusion and emission of lithium ions may occur according to the position of an electrode surface. In this case, there is a problem in that the lifetime of a battery to which large stress is applied due to charge and discharge is deteriorated.

To avoid this problem, investigation has been made into a technology of using a lithium ion conductive polymer in an electrolyte or binder, or a technology of forming a film that is derived from an additive such as a carboxylic acid on a surface of a battery active material.

JP-A-2002-373643 discloses a technology in which a particle surface of at least one of a cathode active material and an anode active material is partially coated with a lithium ion conductive polymer such as a polyethylene oxide (PEO).

JP-A-2001-199961 discloses an invention related to a secondary battery that uses an electrolyte containing a highly polymerized compound that is obtained by polymerizing a molten salt monomer.

JP-A-2002-141111 discloses an invention in which tertiary alkyl carboxylic acid ester is contained in at least one of a cathode, an anode, and an electrolyte to construct a non-aqueous secondary battery.

JP-A-63-193954 discloses an invention related to a secondary battery that uses a lithium ion conductive polymer electrolyte. JP-A-2002-33016 discloses an invention related to a secondary battery using a high molecular solid electrolyte in which ion conductivity is improved by adding a metal salt. Japanese Patent No. 3960193 discloses a secondary battery that includes a hydrophilic binder composed of a cellulose derivative, and a binder that contains a polyether structure and has affinity for the electrolytic solution, or a secondary battery that uses a block-type hydrophilic binder having affinity for an electrolytic solution. The block-type hydrophilic binder is composed of a cellulose derivative in which a side chain having a polyether structure and having affinity for electrolytic solution is grafted. JP-A-2006-66320 discloses a lithium secondary battery that uses a non-aqueous electrolytic solution containing anhydrous carboxylic acid organic compound.

### SUMMARY OF THE INVENTION

The present invention is made to solve the following three problems in consideration of the related art.

A first problem is to prevent a film, which is inactive to a surface of an electrode active material, from being newly formed by causing the electrode active material not to directly come into contact with an electrolytic solution. The volume of the active material is expanded when lithium ions are occluded. In a case where surfaces of particles are partially exposed, accompanying the expansion of the active material particles, an area of an exposed portion increases. As a result, a new film is apt to grow. Therefore, it is important to cover the active material particles with a lithium ion conductive polymer.

A second problem is to improve the durability of the film. When a distal end of the polymer is bonded to a surface atom of the electrode active material, even when the active material particles are expanded or contracted, a polymer is not dropped out, and thus a polymer film, which is excellent in durability over a long period of time, may be formed.

A third problem is to apply an electrical charge to the polymer which is coordinated to a cation (lithium ion) for transmission of lithium ions. That is, a plurality of portions having an anion or unpaired electron are present in the polymer, the lithium ions are bonded to the portions, and thus may move between other portions. Therefore, it is not suitable for the cation to be present in the polymer.

An object of the invention is to improve a load characteristic, a cycle lifetime, and a storage characteristic in a lithium ion battery for an automobile use such as an electric vehicle use, or for a stationary use such as energy storage use so as to provide a battery having a long lifetime.

Characteristics of the invention are as follows.

According to an aspect of the invention, there is provided a polymer coated active material including an active material that occludes and emits lithium ions, and a polymer compound that is bonded to the active material, in which the polymer compound is at least one kind of a structure I, a structure II, a structure III, and a structure IV.

X₁—(OCR₂CR₂)ₙ—Y₁—COO—Z (structure I)

X₁—(OCR₂CR₂)ₙ—Y₁—COO—Z (structure II)

X₂—(OCR₂)ₙ—Y₂—COO—Z (structure III)

X₂—(OCR₂)ₙ—Y₂—COO—Z (structure IV)

Here, X₁ represents any one of hydrogen, a hydrocarbon group having a carbon number of 3 n or less, a halogenated hydrocarbon group having a carbon number of 3 n or less, Z—OOC—Y₁—, and Z—COO—Y₁—. —OOC— and —COO— are carboxylic groups, and they are different only in that the arrangement of atoms is inverted. X₂ represents any one of hydrogen, a hydrocarbon group having a carbon number of 2 n or less, a halogenated hydrocarbon group having a carbon number of 2 n or less, Z—OOC—Y₂—, and Z—COO—Y₂—. When X₂ is either Z—OOC—Y₂— or Z—COO—Y₂—, this means that the bonding is performed at Z of two places. Y₁ represents a hydrocarbon group having a carbon number of 3 n or less, a hydrocarbon group that includes an ester bond and has a carbon number of 3 n or less, or a single bond. Y₂ represents a hydrocarbon group having a carbon number of 2 n or less, a halogenated hydrocarbon group having carbon number of 3 n or less, or a single bond. R represents either hydrogen or halogen. Z represents an element that is present on a surface of particles of the cathode active material or the anode active material. n is an integer of 1 or more.

According to another aspect of the invention, there is provided a lithium ion secondary battery including a cathode that is capable of occluding and emitting lithium ions, and an anode that is capable of occluding and emitting the lithium ions. The cathode includes a cathode composite material, the anode includes an anode composite material, the cathode composite material contains the cathode active material, the anode composite material contains the anode active material, and the cathode active material or the anode active material is the polymer coated active material described above.

According to the invention, a load characteristic, a cycle lifetime, and a storage characteristic of the lithium ion secondary battery are improved, and thus a battery having a long lifetime may be provided. The above-described problems, configurations, and effects will be apparent in the following embodiment.

### BRIEF DESCRIPTION OF THE DRAWINGS

FIG. 1 is a drawing illustrating a lithium ion secondary battery; and

FIG. 2 is a drawing illustrating a module using the lithium ion secondary battery.

### DETAILED DESCRIPTION OF THE INVENTION

Hereinafter, an embodiment of the invention will be described with reference to the attached drawings and the like. The following description represents a specific Embodiment of the invention. However, the invention is not limited to the description, and various modifications and changes maybe made without departing from a technical sprit disclosed in this specification. In addition, in the entire drawings for describing the invention, like reference numerals will be given to like parts having substantially the same functions, and description thereof will not be repeated.

In the related art, when a current value of a charge and discharge of a lithium ion battery is increased, since a current per unit area (that is, current density) of an electrode increases, uneven heat generation occurs at the inside of the battery, and thus a variation in an amount of occlusion and emission of lithium ions may occur according to a position of an electrode surface.

A battery active material to which large stress is applied due to the charge and discharge may be deteriorated as described below. That is, active material particles may be dropped out from other particles, or suffer a deterioration that a film on a surface of the active material grows due to decomposition of an electrolytic solution. When the deterioration proceeds, the output of a battery decreases, and thus the lifetime thereof maybe deteriorated. Particularly, when the cycle of charge and discharge is repeated under a high-temperature environment, a voltage drop may be significant. This is because the particles of the battery active material are repeatedly expanded and contracted due to the charge and discharge cycle, and thus an electronic network between particles is gradually cut.

The present inventors made a thorough investigation to solve the above-described problems. As a result, they found out means for realizing a long lifetime of a battery by causing a polymer compound having lithium ion conductivity to bond to a cathode active material or anode active material that is used in a lithium ion battery.

As a configuration of causing the polymer compound to bond onto the cathode active material or anode active material, a structure I, a structure II, a structure III, and a structure IV that are described below may be used.

X₁—(OCR₂CR₂)ₙ—Y₁—COO—Z (structure I)

X₁—(OCR₂CR₂)ₙ—Y₁—COO—Z (structure II)

X₂—(OCR₂)ₙ—Y₂—COO—Z (structure III)

X₂—(OCR₂)ₙ—Y₂—COO—Z (structure IV)

X₁ represents any one of hydrogen, a hydrocarbon group having a carbon number of 3 n or less, a halogenated hydrocarbon group having a carbon number of 3 n or less, Z—OOC—Y₁—, and Z—COO—Y₁—. X₂ represents any one of hydrogen, a hydrocarbon group having a carbon number of 2 n or less, a halogenated hydrocarbon group having a carbon number of 2 n or less, Z—OOC—Y₂—, and Z—COO—Y₂—. When X₂ is either Z—OOC—Y₂— or and Z—COO—Y₂—, this means that the bonding is performed at Z of two places. Y₁ represents a hydrocarbon group having a carbon number of 3 n or less, a hydrocarbon group that includes an ester bond and has a carbon number of 3 n or less, or a single bond. Y₂ represents a hydrocarbon group having a carbon number of 2 n or less, a halogenated hydrocarbon group having carbon number of 3 n or less, or a single bond. R represents either hydrogen or halogen. Z represents an arbitrary element that is present on a surface of particles of the cathode active material or the anode active material. n is an integer of 1 or more.

Here, —(OCR₂CR₂)ₙ— and —(OCR₂)ₙ that are portions to which ether is connected are referred to as a polyether portion. In addition, COO—and —OOC—, which connect between the polyether portion and Z, or between Y and Z, are referred to as a carboxylic acid bonding portion. Both oxygen in the polyether portion and two kinds of oxygen in the carboxylic acid bonding portion have lone-pair electrons, such that these may be coordinated to lithium ions. As a result, lithium ions are taken off and removed from a solvent that is coordinated in the electrolytic solution, and thus it is possible for the solvent not to reach the electrode active material together with the lithium ions. In addition, since a plurality of oxygen atoms are present in the polymer compound, the lithium ions are bonded to the oxygen atoms, and may move between other oxygen atoms. The polyether bonding portions shown in the structures I to IV may be horizontally inverted.

A bond with a surface of the electrode active material that is shown in right ends of the structures I to IV is formed, such that the entirety or part of the surface of the electrode active material may be coated. As a result, it is difficult for the electrode active material to directly come into contact with the electrolytic solution, and thus even when the volume of particles at the time of occluding the lithium ions increases, a new film does not grow.

Since the distal end of the polymer compound is bonded to a surface atom Z of the electrode active material, even when the active material particles are expanded or contracted, the polymer is not dropped out from the electrode active material, and a polymer film that is excellent in durability may be maintained over a long period of time.

The polyether portions may have a repetitive structure of —OCR₂CR₂— or a repetitive structure of —OCR₂— as described above, but may have a repetitive structure in which —OCR₂CR₂— and —OCR₂— have periodicity, or a structure in which both are randomly mixed. Furthermore, the polyether portion may contain other functional groups such as an alkyl group and a phenyl group within a range that does not hinder lithium ion conduction.

Any of the structures I to IV may be used alone or two or more kinds thereof may be used in combination. It is considered that when the polymer compound is bonded to the cathode active material or the anode active material, detachment of the polymer compound from the active material surface due to the expansion and contraction of the active material may be suppressed. Therefore, cutting of an electronic network between particles may be suppressed. As a result, it is considered that a cycle life performance and a storage characteristic may be improved. A material in which a polymer compound is bonded to the cathode active material or anode active material is referred to as a coated active material.

The polymer compound of the invention has an ether bond. An ether bond portion promotes detachment of a solvent from lithium ions in an electrolytic solution, and secures a path through which only the lithium ions transmits, such that the ether bond portion has a function of preventing the solvent from being excessively discomposed on the surface of the active material of the battery.

As a result, an increase in resistance of the electrode is suppressed. Therefore, the ether bond portion is effective for output maintenance of the battery.

In addition, when X₁ is set as Z—OOC—Y₁ and Z—COO—Y₁—, and X₂ is set as Z—OOC—Y₂— and Z—COO—Y₂, the portions of X₁ and X₂ may be bonded to Z on the surface of the active material. According to this configuration, a polymer compound of one molecule is bonded to the surface of the active material at two points, and thus there is a merit in that the bonding power between the polymer compound and the active material particles may be intensified.

As described above, when each of the active materials is configured in such a manner that the polymer compound is bonded to the surface thereof, the present inventors consider that a long lifetime of the battery may be realized by a mechanism to be described below.

The cathode active material and the anode active material are expanded and contracted in regard to the volume thereof due to a variation in a storage amount of the lithium ions, which accompanies charge and discharge. When the active materials are expanded, particles push one another and thus position may vary. When the volume of the active material that emits lithium ions is decreased while the variation in the position is maintained, the contact between particles may be considered to be deteriorated. When the active material is configured in such a manner that the polymer compound is bonded to the surface thereof, it is considered that the active material is expanded or contracted, the distance between particles is restored, contact failure does not occur, and a moving path of the lithium ions between active material particles may be secured. This is because the polymer compound has elasticity.

In addition, when the active material is configured in such a manner that the polymer compound is bonded to the surface thereof, it is considered that an effect in which diffusion of the lithium ions to the active material from an electrolytic solution becomes easy may be obtained. Since the polyether portion that carries the lithium ions and the active material are bonded to each other by the carboxylic acid bonding portion, it is considered that the lithium ions may be smoothly carried to the active material compared to a case in which the polymer compound is only coated on the surface of the active material. That is, a preferable solid electrolyte coating film of the lithium ions may be obtained. In addition, due to the formation of the above-described bond, the coated state may be maintained over a long period of time.

When the lithium ions are occluded into the active material, it is considered that the lithium ions move from X of the polymer compound to Z. The ether bond portion, —(OCH₂CH₂)ₙ—, or —(OCH₂)ₙ— takes off only the lithium ions that are solvated in the electrolytic solution, and hold the lithium ions to oxygen of the ether portion. The lithium ions move from the left to the right of the formulae of the respective structures. After reaching the carboxylic acid bonding portion, the lithium ions are occluded into the battery active material from Z.

When being emitted from the active material, the lithium ions move from Z to X in the respective structures of the structure I, the structure II, the structure III, and the structure IV. During this movement, the lithium ions move to a solvent of the electrolytic solution that is present in the vicinity of the lithium ions, and the lithium ions are solvated. The solvated lithium ions are diffused into the electrolytic solution.

In addition, the configuration of the invention has an advantage in that an effect as a film (SEI; Solid Electrolyte Interface) may be obtained. Components in the electrolytic solution are reductively decomposed at the periphery of the anode, and generate side reaction products such as lithium carbonate and lithium fluoride. When these side reaction products are excessive, an increase in resistance may be caused. When the active material is coated, this reductive decomposition may be prevented. When the active material is configured in such a manner that the polymer compound is bonded to the surface thereof, it is difficult for a film to be detached from the active material compared to a case in which the polymer compound is only coated on the surface of the active material.

n is an integer of 1 or more, and is associated with the length of the ether bond portion. It is preferable that n be 10 to 100. The length of a unit of —CH₂CH₂O— is approximated to a value (0.45 nm) which is obtained by adding the length of one C—C bond, which is necessary to connect both ends a unit, to the sum (0.3 nm) of the length (0.154 nm) of a C—C bond and the length (0.143 nm) of a C—O bond. The thickness of a coated layer of the polymer compound is preferably larger than a range of 3 to 5 nm. When the thickness is larger than the range, the entire surface of the active material may be covered. In addition, the thickness of the coated layer is preferably 200 nm or less. This is because when the film becomes a thick film having thickness larger than 200 nm, a diffusion distance of the lithium ions becomes longer, and thus the charge and discharge of the active material becomes difficult. In addition, as the film becomes thinner than 200 nm, a rapid charge and discharge may become easy, and the thickness of the film is more preferably 50 nm or less. When converting the thickness into n, 3 to 5 nm corresponds to n of 7 to 11, 200 nm corresponds to n of 440, and 50 nm corresponds to n of 110.

A molecular weight of the polymer has a variation based on an average molecular weight. In this invention, n is defined with the number-average molecular weight of the polymer made as a reference. In consideration of a measurement error, it is preferable that n be approximately in a range of 10 to 500, and more preferably 10 to 100.

From the viewpoints of lithium ion conductivity, it is preferable that Y₁ and Y₂ be as short as possible. Particularly, it is more preferable that Y₁ and Y₂ are single bonds that directly connect the polyether portion and the carboxylic acid bond portion. According to this structure, since a ratio of oxygen that is necessary for the movement of the lithium ions (a ratio of a total atomic weight of oxygen in the polymer molecular weight) is high, the movement speed of the lithium ions becomes fast. That is, there is an advantage in that a battery output may be increased.

Even in a structure in which Y₁ and Y₂ are present, the lithium ions may diffuse while using the ether bond of the polyether portion. In order for the lithium ions to smoothly move between the polyether portion and the carboxylic acid portion, it is preferable that the following conditions be satisfied.

As a representative example of Y₁ and Y₂, alkylene (—CₘH₂ₘ—) may be exemplified. Here, m represents a carbon number of alkylene and is an integer of 1 or more. A part of a straight-chain carbon bond may be substituted with a double bond or triple bond. During carbon-carbon bond, a carbon six-membered ring or a carbon five-membered ring such as an aromatic ring may be inserted, or may be diverged to the carbon atom of the carbon-carbon bond as a side chain. The carbon having this ring structure may be substituted with oxygen or nitrogen. Furthermore, a part or the entirety of hydrogen atoms that are bonded to the carbon atoms that are arranged in a straight chain may be substituted with a halogen element such as fluorine, chlorine, bromine, and iodine. When the substitution is made with a halogen, there is an advantage in which the carbon bond is difficult to be decomposed. In addition, a part of the hydrogen atoms may be substituted with a side chain such as an alkyl group.

In a configuration in which Y₁ and Y₂ are present, the bonding portion of the polyether portion and the carboxylic acid is not directly bonded and is bonded through Y₁ and Y₂. Therefore, it seems that the lithium ions are difficult to move between the polyether portion and the carboxylic acid. However, a layer composed of a plurality of polymer compounds is formed on the surface of the electrode active material, and thus polymer compounds are close to each other. As a result, the lithium ions may be diffused to the surface of the electrode active material while jumping between the plurality of polymer compounds. That is, the lithium ions that reach a bond position of Y may reach the surface of the electrode active material while transferring polyether bond portions of an adjacent polymer compound.

In this manner, it is preferable that the length of Y₁ and Y₂ be restricted so that the lithium ions may move between the plurality of polymer compounds. When the length of Y₁ and Y₂ is too long, there is a high probability that Y portions having insufficient lithium ion conductivity will overlap each other between the plurality of polymer compounds. As a result, a moving path of the lithium ions may be blocked.

A preferable index of limiting the length of Y₁ and Y₂ is that the length of Y₁ and Y₂ be equal to or less than the length of the polyether bond portion. The length of Y₁ and Y₂ is proportional to the carbon number of Y₁ and Y₂. The length of Y₁ when the carbon number is m₁ is set to m₁. In the case of the structure I and the structure II, since the polyether bond portion contains two carbon atoms and one oxygen atom, the length of the bond portion approximates to 3 n. Therefore, it is considered that m₁ is preferably 3 n or less. Similarly, in the structure III and the structure IV, it is considered that the length m₂ of Y₂ is preferably 2 n or less. Absolutely, in a structure in which the polyether bond portion and the carboxylic acid are directly bonded to each other while Y₁ and Y₂ are omitted, a diffusion rate of the lithium ions reaches the maximum.

Furthermore, in a case where Y₁ and Y₂ contains a six-membered ring (for example (—C₆H₄—) in a hydrophobic straight-chain portion, it approximates to the shortest linear distance of two bond positions. That is, the number of carbon atoms is set to 1+2×cos (π/3) at the time of bonding in a para position, the number of carbon atoms is set to 2×cos (π/6) at the time of bonding in a meta position, and the number of carbon atoms is set to one at the time of bonding in an ortho position. This is similar even when a part of carbon is substituted with oxygen. In addition, in the case of the five-membered ring, it also approximates to the shortest distance between two bond positions.

X₁ and X₂ are a chain-shaped or circular shaped alkyl group or aromatic group. In addition, a part of hydrogen or oxygen atoms that make up this group may be substituted with oxygen or a functional group (a hydroxyl group, a carbonyl group, a carboxylic acid group, or the like) containing oxygen. In addition, a part or the entirety of the hydrogen atoms may be substituted with halogen such as fluorine. In this manner, chemical or thermal stability is increased, and thus this is more appropriate. However, this substitution is not requisite to obtain an effect of the invention, and X₁ and X₂ may be selected from hydrocarbons having an arbitrary structure.

When X₁ and X₂ are set as an alkyl group of CH₃—(CₘH₂ₘ)—, a carbon number m+1 maybe an arbitrary value. Apart of carbons may be changed to an ether bond, or a part of hydrogen atoms maybe substituted with halogen. In addition, an aromatic ring may be inserted in a carbon chain.

Straight-chains of the ether bond portion or X₁ and X₂ may be connected to oxygen, sulfur, or alkylene such as —CH₂— to form a bridge in the polymer molecule. According to this configuration, an effect of reinforcing the structure of the polymer compound may be obtained.

When the hydrogen in the polyether bond portion is substituted with halogen, the chemical stability of the bond portion is improved, and thus this is more preferable. Among halogens, fluorine is particularly suitable because carbon-fluorine bonding energy is large (485 kJ/mol). In addition to fluorine, since the bonding energy of other halogens is C—Cl (339 kJ/mol) , C—Br (285 kJ/mol) , and C—I (213 kJ/mol), respectively, chlorine, bromine, and iodine may be used in this order.

From the viewpoints of lithium ion conductivity, it is preferable that X₁ and X₂ be as short as possible. According to this structure, since a ratio of oxygen atoms that are necessary for the movement of the lithium ions (a ratio of a total atomic weight of oxygen in the polymer molecular weight) is high, the movement speed of the lithium ions becomes fast. That is, there is an advantage in that a battery output may be increased.

In addition, as is the case with Y₁ and Y₂, it is preferable that the length of X₁ and X_{z} be shorter than that of the polyether bond portion. This is appropriate for increasing the diffusion rate of the lithium ions. For example, when X₁ is set as an alkyl group of CH₃—(CₘH₂ₘ)—, the carbon number m+1 may be an arbitrary value. However, in regard to the carbon number, when the length of X₁ is shorter than the length (since repetition of two carbon atoms and one oxygen atom is present n times, it is calculated as 3 n) of the polyether bond portion, X₁ does not hinder the diffusion of the lithium ions. Therefore, this case is preferable. This is because when the carbon number of X₁ is larger than 3 n, there is high probability that polyether bond portions to which X is adjacent overlap each other, and thus X₁ may inhibit desolvation of the lithium ions. A relationship between X₂ and Y₂ is also similar to a relationship between X₁ and Y₁, and the case of X₂ and Y₂ is considered as 2 n.

Z is an arbitrary element, which is bonded to the polymer compound, on the active material. The arbitrary element may be an element as long as this element may form a bond with the carboxylic acid bond portion in the polymer compound. In addition, there is no problem as long as the element has a property that becomes a cation and thus is bonded to oxygen. As the arbitrary element, elements that may form an oxide may be exemplified. For example, transition metal elements such as Ti, Mn, V, Fe, Co, and Ni may be exemplified in addition to carbon, silicon, and tin. The carboxylic acid bond portion forms a chemical bond to the element Z, and the surface of the battery active particle is coated with the polymer compound of the invention. That is, Z is positioned on the surface of the active material particles, and X is positioned at a position that is nearest to the electrolytic solution.

In this invention, the polymer compound and the active material are configured to be directly bonded to each other. To obtain the effect of the invention, the polyether portion and the active material are most preferably directly bonded to each other. However, a part of the polymer compound may be indirectly adhered to the surface of the active material through another lithium ion conductive material (for example, regardless of an organic material containing a polymer such as a polyethylene oxide, or an inorganic material such as a heteropoly acid). From the viewpoints of production, it is preferable that the polymer compound be provided with the carboxylic acid bond portion. It is preferable that a covalent bond be formed between the carboxylic acid and an element Z on the surface of the active material.

To bond the polymer compound of this invention onto the surface of the cathode active material, it is preferable that the polymer compound before being bonded to the active material have a structure of a carboxylic acid anhydride at a distal end. In a case where a polymer compound of an acid type (—COOH) is used at the distal end, a metal making up the cathode active material is dissolved due to acid and thus the active material may be modified. When a polymer compound having a structure of acid anhydride is used, the modification of the active material surface due to acid does not occur.

The two carboxylic acid groups (—COOH) that are necessary to obtain the anhydride structure may be two carboxylic groups contained in one molecule polymer compound, or two carboxylic groups contained in other molecules. A structure of the distal end before the polymer compound is added to the cathode active material is a carboxylic acid in which Z is expressed by hydrogen (H). When this carboxylic acid is heat-treated or dehydrated, an anhydride may be obtained (Formula 1). A bond portion of the anhydride is the following portion in Formula 1. That is,

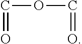

In addition, as a dehydrating agent, known material such as P₂O₅ may be used.

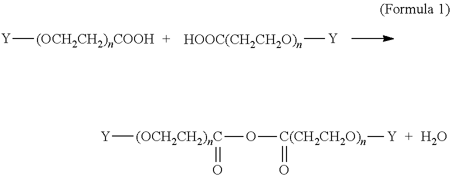

When an acid anhydride type polymer compound is added to the battery active material, a bond is formed on the surface of the active material during initial charge and discharge. Slurry that is obtained by adding an active material, a binder, a conducting material, a polymer compound, and the like to a solvent is prepared. Then, the slurry is applied onto current collectors, and then this slurry is dried to manufacture a cathode and an anode. After a battery assembled, initial charge is performed to bond the polymer compound and the active material. At this time, the acid anhydride is decomposed into —COO and —CO on the cathode surface. The former is bonded to a metal atom on the cathode surface and becomes —COO—Z (Z is a metal atom of the cathode active material). The later is bonded to oxygen on the cathode surface and becomes —COO—Z (Z is an oxygen atom).

This process of bonding the active material and the polymer compound in an acid anhydride type may be used for the preparation of both of the cathode and anode. When the polymer compound is added to the anode and charge is performed in the electrolytic solution, a solvent of the electrolytic solution is reductively decomposed. Oxygen is lost from the solvent, and thus the acid anhydride is converted into two —COO groups. Ultimately, it enters a state in which the polymer compound is bonded to the anode surface.

The polymer compound may be added to the slurry in a state in which the distal end of the carboxylic acid is set as an alkali metal or alkali earth metal salt, and the polymer compound and the active material may be bonded to each other by the initial charge. In the case of using this salt, the electrode may be manufactured from slurry in which water is used as a solvent.

The ether bond portion of the polymer compounds having the structures I to IV or alkyl or hydrogen contained in Y₁ and Y₂ may be substituted with an arbitrary chemical bond such as an ether bond, an ester bond, a carbonyl bond, and an alkylene bond between adjacent polymer compounds, and thereby a plurality of polymer compounds may be bonded (that is, a bridge structure may be formed). The number of chemical bonds may be 1 or more. In addition, the chemical bond may be formed before being formed on the surface of the active material, or may be formed after being bonded to the surface of the active material. One polymer is connected onto the surface of the active material with bonds of two places. Therefore, strong bonding power may be exhibited compared to the structures I to IV in which the polymer is connected to the surface only one place. Therefore, a polymer coating layer that is relatively excellent in durability may be provided.

When forming the bridge structure, a hydroxyl group and a carboxylic group are introduced to a plurality of carbon atoms to which the polymer compound is desired to be bonded according to a known organic synthesis method. Then, a molecule to be bridged (hereinafter, referred to as a bridge molecule), for example, glycol (alcohol having two hydroxyl groups), a hydrocarbon compound having two acyl bonds, or a hydrocarbon compound having two carboxylic acid groups is added to a polymer, and then the bridge molecule may be inserted between a plurality of polymer molecules by a known organic reaction such as a dehydration reaction and a dehalogenation reaction. In addition, when the ether bond, the carbonyl bond, and the ester bond are made to be included in the above-described hydrocarbon, oxygen of the bridge molecule promotes the diffusion of the lithium ions, and thus this is more appropriate.

It is preferable that a ratio of the number of moles of oxygen contained in the polyether portion with respect to the number of moles of oxygen contained in the carboxylic acid bond portion be larger than 10. A description will be made with respect to a case in which n of the polyether bond portion of the polymer of the invention is 10 or more.

Hereinafter, examples of the cathode and anode using the above-described polymer compound will be described.

The above-described polymer compound is mixed to either the cathode active material or the anode active material, or to both, respectively to manufacture the cathode or anode. The active material and the polymer compound are mixed, and a solvent is mixed to the resultant mixture to prepare slurry of the cathode or anode. The solvent which is difficult to penetrate into the polymer compound is preferable.

In a case where the polymer compound of the invention is used in the cathode, for example, cathode active material powder, the polymer compound of the invention, and a binder are mixed, and then a solvent is added to the resultant mixture, and then the resultant mixture is sufficiently mixed and dispersed to prepare slurry.

Representative examples of the cathode active material include LiCoO₂, LiNiO₂, and LiMn₂O₄. In addition to these, LiMnO₃, LiMn₂O₃, LiMnO₂, Li₄Mn₅O₁₂, LiMn₂₋ₓMₓO₂ (however, M=Co, Ni, Fe, Cr, Zn, or Ta, and x=0.01 to 0.2) , Li₂Mn₃MO₈ (however, M=Fe, Co, Ni, Cu, or Zn), Li₁₋ₓAₓMn₂O₄ (however, A=Mg, B, Al, Fe, Co, Ni, Cr, Zn, or Ca, and x=0.01 to 0.1) , LiNi₁₋ₓMₓO₂ (however, M=Co, Fe, or Ga, and x=0.01 to 0.2), LiFeO₂, Fe₂ (SO₄)₃, LiCo₁₋ₓMₓO₂ (however, M=Ni, Fe, or Mn, and x=0.01 to 0.2), LiNi₁₋ₓMₓO₂ (however, M=Mn, Fe, Co, Al, Ga, Ca, or Mg, and x=0.01 to 0.2) , Fe (MoO₄)₃, FeF₃, LiFePO₄, LiMnPO₄, or the like may be exemplified. In this embodiment, LiNi_{1/3}Mn_{1/3}Co_{1/3}O₂ was selected as the cathode active material. However, the cathode active material is not limited to this material because restriction is not imposed to the invention with respect to a cathode material.

A particle size of the cathode active material is defined to be equal to or less than the thickness of a composite material layer. In a case where coarse particles having a size that is equal to or larger than the thickness of the composite material layer are present in the cathode active material powder, the coarse particles are removed in advance using sieve classification, air classification, or the like, and thus particles that are equal to or less than the thickness of the composite material layer are manufactured.

In the cathode, when the polymer compound is bonded to the cathode active material, it is considered that the problem occurring in the vicinity of the cathode may be solved. It is known that the electrolytic solution is oxidized on the cathode active material. When the electrolytic solution is oxidized, there is a problem in that an element Z of the cathode active material is reduced, and thus cannot contribute to a charge and discharge reaction. In addition, Z may be eluted and thus a crystal structure of the cathode active material may be collapsed. In addition, even when this deterioration reaction does not occur, lithium ions are taken into the cathode due to oxidization of the electrolytic solution and thus a charge level of the cathode is lowered, that is, the cathode performs self-discharge. However, when the polymer compound of the invention is used, the polymer compound is bonded to Z, an oxidization reaction site of the electrolytic solution is blocked, and thus an effect of suppressing the oxidization reaction of the above-described electrolytic solution may be obtained. The oxidization reaction of the electrolytic solution is accompanied with generation of gas such as carbon dioxide, such that swelling of battery may be suppressed by using the polymer compound of the invention.

As the binder, known materials such as polyvinylidene fluoride, polyethylene fluoride, polyimide, styrene-butadiene rubber, ethylene-propylene rubber, polyacrylic acid, and the like may be used. The solvent is an organic solvent, water, or the like, and maybe arbitrarily selected as long as this solvent does not modify the polymer compound of the invention.

The polymer compound that is bonded to the surface of the active material has a function of bonding particles in the composite material. Therefore, in the case of using the polymer compound, the amount of binder may be reduced or the binder itself may be omitted. When the amount of binder may be reduced or the binder itself may be omitted, it is considered that resistance in the composite material may be decreased and this decrease in resistance leads to high output of the battery. In regard to a mixing ratio (volume ratio) of the binder and the polymer compound, when a ratio of binder is set to 0 to 1 based on 1 of the polymer compound, 50% or more of a surface area of the active material may be coated with the polymer compound. Therefore, transmission of the lithium ions may be realized. When the ratio of the binder is set to 0 to 0.75, rapid charge and discharge may be realized and thus this is more preferable. A specific gravity (weight per volume) of the binder is substantially the same as that of the polymer compound, such that the ratio of the binder may be expressed as a weight of the binder based on the total weight of the binder and the polymer compound. In addition, the ratio of the binder with respect to the polymer compound may be applied to both the cathode and anode.

As the conducting material, known materials such as graphite, amorphous carbon, graphitizable carbon, carbon black, activated carbon, carbon fiber, and carbon nanotube may be used. Examples of conductive fiber include fiber that is manufactured by carbonizing vapor-phase growth carbon or pitch (a byproduct of petroleum, coal, coal tar, or the like) as a raw material at a high temperature, carbon fiber manufactured from acryl fiber (polyacrylonitrile), and the like. In addition, fiber formed of a metal material, which is a material that is not oxidized and dissolved at a charge and discharge potential of the cathode (normally, 2.5 to 4.3 V with a Li metal reference electrode made as a reference) and has electric resistance lower than that of the cathode active material, for example, corrosion-resistant metals such as titanium and gold, carbides such as SiC and WC, nitrides such as Si₃N₄ and BN, may be used. As a method of manufacturing the fiber, existing methods such as a melting method and a chemical vapor deposition method may be used.

An addition amount of the polymer compound, the binder, and the conducting material is set to 5 to 20% based on the total weight of the composite material including the cathode active material, the conducting material, the polymer compound, and the binder. When the amount of the cathode active material is larger than 95%, the addition amount of the polymer compound of the invention becomes too small, and thus it is difficult to secure a diffusion path of the lithium ions. At the same time, the amount of binder becomes too small, and thus the cathode active material particles are not connected to each other and the performance of the cathode is deteriorated due to charge and discharge cycles. In addition, when the addition amount of the conducting material is decreased, electron conduction between the cathode active material particles having high resistance may be hindered. On the contrary to this, when the amount of the cathode active material becomes small, there is a problem in that the capacity of the battery is decreased.

To realize large-current charge and discharge by making conductivity of the invention be sufficiently exhibited, it is preferable that the addition amount of the polymer compound and the binder be 1 to 7% based on the total weight of the composite material, and be 1% or more based on the total weight of the polymer compound. In addition, when the polymer compound of the invention has a binding function as a binder, the binder may be omitted. A conducting material may be added, or the conducting material and the polymer compound of the invention may be combined and this resultant material may be mixed to the cathode active material.

The above-described slurry is applied to a cathode current collector, and then the slurry is dried by evaporating a solvent, whereby a cathode 110 is manufactured. As the cathode current collector, aluminum foil having the thickness of 10 to 100 μm, aluminum punched-foil having the thickness of 10 to 100 μm and the hole diameter of 0.1 to 10 mm, an expanded metal, a foamed metal plate, or the like may be used. In addition to aluminum, stainless steel, titanium, or the like may be applied as the material of the current collector. In this invention, an arbitrary current collector may be used without being limited to a material, a shape, a manufacturing method, and the like.

For the application to the cathode, existing methods such as a doctor blade method, a dipping method, a spraying method, and the like maybe used without any limitation. In addition, the cathode maybe manufactured by the following method. That is, the cathode slurry is made to adhere to the current collector. Then, an organic solvent is dried. Then, the cathode is pressure-molded using a roll press. In addition, a plurality of composite material layers may be laminated on the current collector by performing the application process to the drying processes in plural times.

In the case of using the polymer compound in the anode, first, the anode active material, the polymer compound of the invention, and a binder are mixed, and a solvent is mixed to the resultant mixture, whereby anode slurry is prepared. The solvent which is difficult to penetrate into the polymer compound is preferable. This is because when the solvent penetrates into the polymer compound, the polymer compound is swelled, and thus there is a problem in that the binding property with the anode active material may be deteriorated. In regard to this peeling-off problem, an appropriate solvent may be selected by adding a solvent to the polymer compound of the invention and by confirming whether or not the peeling-off of a surface layer after the polymer compound is swelled.

A representative example of the anode active material is a carbon material having a graphene structure. That is, natural graphite, artificial graphite, meshophase carbon, expanded graphite, carbon fiber, vapor-phase growth carbon fiber, a pitch-based carbonaceous material, carbonaceous materials such as needle coke, petroleum coke, polyacrylonitrile-based carbon fiber, and carbon black, amorphous carbon materials that are synthesized by pyrolyzing cyclic hydrocarbon compounds of five-membered ring or six-membered ring or cyclic oxygen-containing organic compounds, and the like, which are capable of electrochemically occluding and emitting the lithium ions, may be used. Even in a mixture anode formed of materials such as the graphite, the graphitizable carbon, and the non-graphitized carbon, or a mixture anode or a composite anode in which a metal or an alloy is mixed to the carbon material, there is no problem in executing the invention.

In addition, conductive polymer materials composed of polyacene, polyparaphenylene, polyaniline, or polyacetylene maybe used for the anode. When parts of the conductive polymer contain a hydroxyl group (—OH), a carbonyl group (>C═O), and a carboxylic acid group (—COO—), the invention maybe executed by combining this conductive polymer material and a carbon material having a graphene structure such as the conductive polymer material, the graphite, the graphitizable carbon, and the non-graphitized carbon to the polymer compound of the invention.

The anode active material that may be used in the invention includes aluminum, silicon, tin, and the like that are alloyed with lithium. Furthermore, an anode of an oxide such as lithium titanate may be used. This is because the carboxylic acid bond portion of the polymer compound of the invention is bonded to a metal atom of the anode active material. In this invention, the anode active material is not particularly limited, and others in addition to the above-described materials may be used.

A solvent is added to a mixture composed of the anode active material that is prepared as described above, a binder, and the polymer compound of the invention, and the resultant material is sufficiently mixed and dispersed to prepare slurry. As the binder, known materials such as polyvinylidene fluoride, polyimide, styrene-butadiene rubber, ethylene-propylene rubber, and carboxymethyl cellulose maybe used. The solvent is an organic solvent, water, or the like, and may be arbitrarily selected as long as this solvent does not modify the polymer compound of the invention.

The total addition amount of the polymer compound of the invention and the binder with respect to the anode active material is set to 1 to 10% by weight with respect to the total weight of the composite material composed of the anode active material, the conducting material, the polymer compound, and the binder. Since the electrical resistance of the anode active material is lower than that of the cathode active material, an amount of the anode active material may be increased. Therefore, a weight ratio of the anode active material may be set to a high value of 99 to 90%.

When the amount of the anode active material is too much, since the addition amount of the polymer compound of the invention becomes too small, it is difficult to secure the diffusion path of the lithium ions. At the same time, the amount of binder becomes too small, and thus the anode active material particles are not connected to each other and the performance of the anode is deteriorated due to charge and discharge cycles. On the contrary to this, when the amount of the anode active material becomes small, there is a problem in that the capacity of the battery is decreased. The reason why the addition amount is to be within an appropriate range is the same as the case of the cathode.

To realize large-current charge and discharge by making conductivity of the invention be sufficiently exhibited, it is preferable that the addition amount of the polymer compound and the binder be 1 to 7% based on the total weight of the composite material, and be 1% or more based on the total weight of the polymer compound. In addition, when the polymer compound of the invention has a binding function as a binder, the binder may be omitted. A conducting material may be added, or the conducting material to which the polymer of the invention is combined may be used.

The above-described slurry is applied to an anode current collector, and then the slurry is dried by evaporating a solvent, whereby an anode 112 is manufactured. As the anode current collector, copper foil having the thickness of 10 to 100 μm, copper punched-foil having the thickness of 10 to 100 μm and the hole diameter of 0.1 to 10 mm, an expanded metal, a foamed metal plate, or the like may be used. In addition to copper, stainless steel, titanium, or the like may be applied as the material of the current collector. In this invention, an arbitrary current collector may be used without being limited to a material, a shape, a manufacturing method, and the like.

Next, the anode slurry is made to adhere to the current collector by a doctor blade method, a dipping method, a spraying method, or the like. Then, an organic solvent is dried. Then, the anode is pressure-molded using a roll press. In addition, a plurality of composite material layers may be laminated on the current collector by performing the application process to the drying processes in plural times.

In this invention, the anode may be manufactured by a method in the related art, and the polymer compound of the invention may be used only for the cathode. In the case of applying the method in the related art for the manufacturing of the anode, a solvent is added to a mixture of the anode active material and a fluorine-based binder or a rubber-based binder in the related art so as to prepare the anode slurry. This slurry is applied to the anode current collector and then is dried, whereby the anode is manufactured. As a material that maybe used for the anode current collector, the same material as that used when manufacturing the anode of the invention may be selected. In this invention, an arbitrary current collector may be used without being limited to a material, a shape, a manufacturing method, and the like. The above-described existing method may be adopted to manufacture the anode slurry without any limitation.

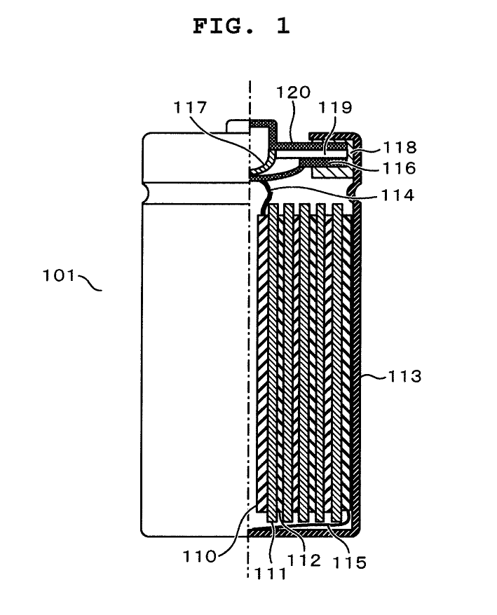

Until now, a description was made with respect to the polymer compound, and the cathode and anode using the polymer compound. Next, a general lithium ion battery will be described with reference to FIG. 1.

FIG. 1 schematically shows an inner structure of a lithium ion battery 101. The lithium ion battery 101 is an electrochemical device that is capable of storing or using electrical energy by occluding and emitting lithium ions to and from the electrode in a non-aqueous electrolyte.

In FIG. 1, a reference numeral 110 represents the cathode, a reference numeral 111 represents a separator, a reference numeral 112 represents an anode, a reference numeral 113 represents a battery casing, a reference numeral 114 represents a cathode current collecting tab, a reference numeral 115 represents an anode current collecting tab, a reference numeral 116 represents an inner lid, a reference numeral 117 represents an internal pressure open valve, a reference numeral 118 represents a gasket, a reference numeral 119 represents a PTC (Positive Temperature Coefficient) resistive element, and a reference numeral 120 represents a battery lid. The battery lid 120 is an integral component made up by the inner lid 116, the internal pressure open valve 117, the gasket 118, and the PTC resistive element 119. The mounting of the battery lid 120 to the battery casing 113 in this embodiment is performed by swaging, but other methods such as welding and adhesion may be adopted depending on a shape of the battery lid 120.

A container used for the battery shown in FIG. 1 is a type having the bottom, such that the container is described as the battery casing 113. A cylindrical container without a bottom surface may be also used. This circular container is attached to the bottom surface of the battery lid 120 shown in FIG. 1, and the anode 112 is connected to the battery lid 120. Even when a battery container having an arbitrary shape is used in accordance with a terminal attaching method, the effect of the invention is not affected.

The cathode current collecting tab 114 that is welded to the cathode current collector is disposed at an upper portion of electrode groups, and is welded to the inner lid 116. The inner lid 116 is conducted from the internal pressure open valve 117 to the battery lid 120. At a lower side of the electrode group, the anode current collecting tab 115 that is welded to the anode current collector is disposed and is welded to the bottom surface of the battery casing 113. According to this configuration, a convex portion of the inner lid 116 and the bottom surface of the battery casing 113 are electrically conducted, and thus the cathode 110 and the anode 112 may be charged or discharged.

In addition to the cylindrical structure using winding shown in FIG. 1, the structure of the electrode group may have an arbitrary shape such as a flat structure using the winding and a square shape in which strip-shaped electrodes are laminated. In response to this structure, as a shape of the battery casing, a cylindrical shape, a flat elliptic shape, a square shape, or the like may be selected in accordance with the shape of the electrode group.

A material of the battery casing 113 maybe selected from materials including aluminum, stainless steel, nickel-plated steel material, and the like that have corrosion resistance with respect to the non-aqueous electrolyte. In addition, in the battery shown in FIG. 1, the battery casing 113 is connected to the anode current collecting tab 115, but on the contrary to this, the cathode current collecting tab 114 and the anode current collecting tab 115 may be connected to the battery casing 113 and the inner lid 116, respectively. The above-described material is selected in such a manner that an inner wall of the battery casing 113 and the current collecting tabs, which come into contact with the non-aqueous electrolyte, are not deteriorated due to corrosion or alloying with the lithium ions.

After the cathode 110 and the anode 112 are manufactured, the separator 111 is inserted between these electrodes to prevent a short circuit of the cathode 110 and the anode 112. The cathode 110, the anode 112, and the separator 111 are wound, whereby the cylindrical electrode group is manufactured. The separator 111 may be wound to the outermost periphery of the electrode group, and thus insulation between the electrode group and the battery casing 113 is secured. On the surfaces of the separator 111 and the respective electrodes, and in pores thereof, the electrolytic solution containing the electrolyte and the non-aqueous solvent is maintained.

As the separator 111, a multi-layer film in which polyolefin-based polymer sheets composed of polyethylene, polypropylene, or the like, or fluorine-based polymer sheets composed of a polyolefin-based polymer or polyethylene tetrafluoride are fusion-bonded to each other may be used. A mixture of a ceramics and a binder maybe formed in a thin-layer shape on the surface of the separator 111, which=prevents the separator 111 from being contracted when the temperature of the battery is raised. Since it is necessary for the lithium ions to be transmitted through the separator 111 at the time of charging or discharging the battery, generally, the separator 111 having a pore diameter of 0.01 to 10 μm and a porosity of 20 to 90% may be used for the lithium ion battery 101.

As a representative example of the electrolytic solution that maybe used in the invention, a solution, which is obtained by dissolving lithium hexafluorophosphate (LiPF₆) or lithium tetrafluoroborate (LiBF₄) as an electrolyte in a solvent in which dimethyl carbonate, diethyl carbonate, ethyl methyl carbonate, or the like is mixed to ethylene carbonate, may be exemplified. The invention may use other electrolytic solutions without being limited to a kind of the solvent or the electrolyte, and a mixing ratio of the solvent. The electrolyte may be used in a state of being contained in an ion conductive polymer such as polyvinylidene fluoride and polyethylene oxide. In this case, the separator is not necessary. In addition, examples of the solvent that may be used for the electrolytic solution include non-aqueous solvents such as propylene carbonate, ethylene carbonate, butylene carbonate, vinylene carbonate, γ-butylolactone, dimethyl carbonate, diethyl carbonate, methyl ethyl carbonate, 1,2-dimetoxy ethane, 2-methyl tetrahydrofuran, dimethyl sulfoxide, 1,3-dioxolane, formamide, dimethyl formamide, methyl propionate, ethyl propionate, phosphate trimester, trimethoxy methane, dioxolane, diethyl ether, sulfolane, 3-methyl-2-oxazolidinone, tetrahydrofuran, 1,2-diethoxy ethane, chloroethylene carbonate, and chloroprolylene carbonate. Other solvents may be used as long as these solvents are not decomposed on the cathode or anode that is embedded in the battery of the invention.

In addition, as the electrolyte, various kinds of lithium salts such as imide salts of lithium represented by LiPF₆, LiBF₄, LiClO₄, LiCF₃SO₃, LiCF₃CO₂, LiAsF₆, LiSbF₆, in chemical formula, or lithium trifluoromethanesulfonimide may be exemplified. A non-aqueous electrolytic solution that is obtained by dissolving this salt in the above-described solvent may be used as the electrolytic solution for the battery. Other electrolyte may be used as long as these electrolytes are not decomposed on the cathode or anode that is embedded in the battery of the invention.

In the case of using a solid polymer electrolyte (polymer electrolyte), ion conductive polymers such as ethylene oxide, acrylonitrile, polyvinylidene fluoride, methyl methacrylate, hexafluoropropylene, and polyethylene oxide may be used for the electrolyte. In the case of using this solid polymer electrolyte, there is an advantage in that the separator 111 may be omitted.

In addition, ionic liquid may be used. For example, a combination that is not decomposed in the cathode and the anode may be selected from 1-ethyl-3-methylimidazolium tetrafluoroborate (EMI-BF₄), a mixed complex of lithium salt LiN(SO₂CF₃)₂(LiTFSI), triglyme, and tetraglyme, cyclic quaternary ammonium-based cation (N-methyl-N-propylpyrrolidinium is exemplified), and imide-based anion (bis(fluorosulfonyl)imide is exemplified), and this combination may be used for the lithium ion battery of the invention.

Hereinafter, the invention will be described in more detail using embodiments, but the technical scope of the invention is not limited thereto.

### EMBODIMENT 1

### Manufacturing of Cathode

A cathode was manufactured by using LiNi_{1/3}Mn_{1/3}Co_{1/3}O₂ as the cathode active material having an average particle size of 10 μm, carbon black as the conducting material, and polyvinylidene fluoride (PVDF) as the binder, and the following experiments were performed. A weight composition of the cathode active material, the conducting material, and the binder was set to 88:7:5. An area of an electrode to which cathode slurry was applied was set to 400 cm×5 cm, and the thickness of the composite material was set to 50 μm. In addition, the polymer compound of the invention was not used for the cathode.

### Manufacturing of Anode

Natural graphite having an average particle size of 15 μm was used as the anode active material, a carboxylic acid anhydride of [CH₃—(OCH₂CH₂)ₙCO]₂O (in structure I, X is CH₃—, Y is a single bond, R is H, and n is 200 to 300) was used as the polymer compound, styrene-butadiene rubber was used as the binder, and carboxymethylcellulose sodium was used as a thickening agent. On the other hand, a weight composition of the natural graphite, the polymer compound, the binder, and the thickening agent was set to 95:2:1.5:1.5. An area of an electrode to which anode slurry was applied was set to 500 cm×5.2 cm, and the thickness of the composite material was set to 30 μm.

In addition, the reason why the range of n value of the polymer compound is defined is that polymerization reaction level to form the polyester bond is deviated in a manufacturing lot unit. The polyester bond portion was formed by a ring-opening polymerization reaction of polyethylene oxide. Other methods may be used. A plurality of polymer compounds having different n within the deviation range were used and thus a plurality of anodes were manufactured, whereby different batteries were manufactured using the respective anodes. A battery performance evaluation was performed for each battery in which n is different. In embodiments to be described later, deviation is present in n, but this is similar to Embodiment 1.

Anode active material powders and the polymer compound were mixed, and methanol as a solvent was dropped to the resultant mixture, and whereby slurry was prepared. Other than methanol, the solvent may be changed to a lower alcohol having a carbon number of 4 or less (e.g., ethanol, propanol and butanol). In a dispersion treatment, a planetary mixer and a disperser were used. The slurry was applied to copper foil having the thickness of 10 μm, and then slurry was dried by evaporating the solvent. In addition, compression was performed using a roll press until the composite material layer has density of 1.4 to 1.5 g/cm³.

### Manufacturing of Battery

A wound electrode group was accommodated in the battery casing 113, and then an electrolytic solution was added. The electrolytic solution was obtained by dissolving 1 M LiPF₆ to a solvent obtained by mixing ethylene carbonate (EC) and dimethyl carbonate (DMC) in a volume ratio of 1:2. Vinylene carbonate of 1% by volume based on a total volume of the electrolytic solution was added as a small amount additive.

The battery lid 120 and the battery casing 113 were attached by swaging, whereby five cylindrical lithium ion batteries shown in FIG. 1 were manufactured.

### Battery Evaluation Method and Result

These batteries were charged with 4.2 V at 0.2 C-rate (a current value is 0.4 A), and then was discharged with a current (2 A) at 1 C-rate to 3.0 V. The capacity of the battery at this time was 2±0.1 Ah. A capacity deviation was present because n was deviated in a range of 200 to 300. During a charge of the first time, a reduction current, which causes a chemical reaction of the polymer compound on the anode, was made to flow, and the fixing was terminated. During this reaction, the solvent of the electrolytic solution is reductively decomposed, oxygen detached from the solvent is taken to an acid anhydride, this anhydride varies two —COO groups, and ultimately, it enters a state in which the polymer compound was bonded to the anode surface. An amount of electricity that is necessary for the fixing may be assumed as a differential value between the charge capacity of the first time and the discharge capacity of the first time. These batteries were set in a thermostatic chamber of 50° C., and then a cycle experiment was performed under the above-described charge and discharge conditions. After the experiment of 500 cycles was terminated, a battery temperature was decreased to room temperature, and the charge and discharge experiment was performed under the same conditions. Results thereof were written in a column of Embodiment 1 in Table 1. A capacity retention ratio (a ratio of the discharge capacity with respect to the initial capacity 2±0.1 Ah) after elapse of 500 cycles was 93±2%. DC resistance was increased by 140±10% with respect to an initial value. In addition, a deviation between the capacity retention ratio and the DC resistance occurs because n is deviated in a range of 200 to 300.

### EMBODIMENT 2

### Manufacturing of Anode

The anode was manufactured by the same conditions as Embodiment 1 except that n of the polymer compound in Embodiment 1 was increased to 600 to 700.

### Battery Evaluation Method and Result

An initial capacity after initial aging was 1.8±0.1 Ah. The reason why the initial capacity was decreased compared to Embodiment 1 was because the initial DC resistance was increased by 20 to 30%. A capacity retention ratio after elapse of 500 cycles at 50° C. was 93±2%. The capacity retention ratio was substantially the same as the result of Embodiment 1, but since the initial capacity was low, the capacity at a point of time after 500 cycles were elapsed was decreased.

### EMBODIMENT 3

### Manufacturing of Anode

An anode in which the binder (styrene-butadiene rubber), which was used for the anode in Embodiment 1, was omitted, and an addition amount of the anode active material was increased instead of the binder was manufactured. That is, a weight composition of the natural graphite, the polymer compound, the binder, and the thickening agent was set to 96.5:2:0:1.5.

When manufacturing the anode, other conditions were similar to those in Embodiment 1. Then, evaluation was performed.

### Battery Evaluation Method and Result

A capacity retention ratio (a ratio of the discharge capacity with respect to the initial capacity 2±0.1 Ah) after elapse of 500 cycles was 91±2%. DC resistance was increased by 160±10% with respect to an initial value.

### EMBODIMENT 4

### Manufacturing of Anode

The polymer compound that was used for the anode in Embodiment 1 was set as a carboxylic acid anhydride of [CH₃—(OCH₂CH₂)ₙ(CH₂)ₘCO]₂O (in structure I, X is CH₃—, Y is —(CH₂)m-, R is H). In addition, Embodiment 4 is different from Embodiment 1 in that n is 10 to 100. m was set to 50 to 300. When manufacturing the anode, other conditions were similar to those in Embodiment 1. Then, evaluation was performed.

### Battery Evaluation Method and Result

An initial capacity after initial aging was 2±0.1 Ah. Then, the charge and discharge cycle experiment was performed in a thermostatic chamber of 50° C. A capacity retention ratio (a ratio of the discharge capacity with respect to the initial capacity 2±0.1 Ah) after elapse of 500 cycles was 94±2%. In addition, DC resistance was increased by 140±10% with respect to an initial value.

### EMBODIMENT 5

### Manufacturing of Anode

The polymer compound that was used for the anode in Embodiment 1 was set as a carboxylic acid anhydride of [CH₃—(OCH₂)ₙCO]₂O (in structure III, X is CH₃—, Y is a single bond, R is H, and n is 400 to 500).

When manufacturing the anode, other conditions were similar to those in Embodiment 1. Then, evaluation was performed.

### Battery Evaluation Method and Result

An initial capacity after initial aging was 2±0.1 Ah. Then, the charge and discharge cycle experiment was performed in a thermostatic chamber of 50° C. A capacity retention ratio (a ratio of the discharge capacity with respect to the initial capacity 2±0.1 Ah) after elapse of 500 cycles was 94±2%. In addition, an increasing rate of DC resistance after the charge and discharge experiment at 50° C. was 145±10%.

### EMBODIMENT 6

### Manufacturing of Anode

The polymer compound that was used for the anode in Embodiment 1 was set as a carboxylic acid anhydride of [CH₃—(OCF₂)ₙCO]₂O (in structure III, X is CH₃—, Y is a single bond, R is F, and n is 400 to 500).

When manufacturing the anode, other conditions were similar to those in Embodiment 1. Then, evaluation was performed.

### Battery Evaluation Method and Result

An initial capacity after initial aging was 2±0.1 Ah. Then, the charge and discharge cycle experiment was performed in a thermostatic chamber of 50° C. A capacity retention ratio (a ratio of the discharge capacity with respect to the initial capacity 2±0.1 Ah) after elapse of 500 cycles was 96±2%. The increasing rate of DC resistance after the charge and discharge experiment at 50° C. was 130±10%.

### EMBODIMENT 7

### Manufacturing of Anode

The polymer compound that was used for the anode in Embodiment 1 was set to [CH₃—(OCF₂CF₂)ₙCO]₂O (in structure I, X is CH₃—, Y is a single bond, R is F, and n is 400 to 500). In addition, the polymer compounds were configured to have a bridge structure with each other.

The polymer compound [CH₃—(OCF₂CF₂)ₙCO]₂O (in structure I, X is CH₃—, Y is a single bond, R is F, and n is 500 to 600) was set as a polymer A that is a raw material. A part of fluorine in a repetitive structure of —(OCF₂CF₂)— of the polymer A was randomly changed to an acyl bond portion and —CClO. A substitution amount was set to 3 to 5 per one molecule. This was set as a polymer B. Next, A part of fluorine in a repetitive structure of —(OCF₂CF₂)— of the polymer A was randomly substituted with a hydroxyl group of —OH. A substitution amount was set to 3 to 5 per one molecule. This was set as a polymer C. The polymer B and the polymer C were added to the anode active material in an equivalent amount and these were mixed, whereby an anode active material coated with the polymer compound of the invention was manufactured. The acyl bond —CClO and the hydroxyl group —OH were bonded to each other, and thus a bridge of —C(═O)—O— was formed between the polymer B and the polymer C. HCl that is a byproduct of this reaction may be removed from the surface of the anode active material by rinsing the anode active material with water and by vacuum-drying this material.

When manufacturing the anode, other conditions were similar to those in Embodiment 1. Then, evaluation was performed.

### Battery Evaluation Method and Result

An initial capacity after initial aging was 2±0.1 Ah. Then, the charge and discharge cycle experiment was performed in a thermostatic chamber of 50° C. A capacity retention ratio (a ratio of the discharge capacity with respect to the initial capacity 2±0.1 Ah) after elapse of 500 cycles was 96±2%. The increasing rate of DC resistance after the charge and discharge experiment at 50° C. was 120±10%, and durability was improved compared to the polymer compound in Embodiment 1.

### EMBODIMENT 8

### Manufacturing of Anode

The polymer compound that was used for the anode in Embodiment 1 was set as CH₃—(OCF₂)ₙCOOLi (in structure III, X is CH₃—, Y is a single bond, R is F, and n is 400 to 500).

When manufacturing the anode, other conditions were similar to those in Embodiment 1. Then, evaluation was performed.

### Battery Evaluation Method and Result

An initial capacity after initial aging was 2±0.1 Ah. Then, the charge and discharge cycle experiment was performed in a thermostatic chamber of 50° C. A capacity retention ratio (a ratio of the discharge capacity with respect to the initial capacity 2±0.1 Ah) after elapse of 500 cycles was 95±2%. The increasing rate of DC resistance after the charge and discharge experiment at 50° C. was 130±10%.

### EMBODIMENT 9

### Manufacturing of Cathode

A cathode was manufactured by using LiNi_{1/3}Mn_{1/3}Co_{1/3}O₂ as the cathode active material having an average particle size of 10 μm, carbon black as the conducting material, and the carboxylic acid anhydride of polymer compound [CH₃—(OCH₂)ₙCO]₂O (in structure III, X is CH₃—, Y is a single bond, R is H, and n is 400 to 500) that was used in Embodiment 5. Polyvinylidene fluoride was used as the binder. A weight composition of the cathode active material, the conducting material, the binder, and the polymer compound was set to 88:7:4:1. An area of an electrode to which cathode slurry was applied was set 400 cm×5 cm, and the thickness of the composite material was set to 50 μm.

### Manufacturing of Anode

This anode was manufactured similarly to Embodiment 1.

When manufacturing the anode, other conditions were similar to those in Embodiment 1. Then, evaluation was performed.

### Battery Evaluation Method and Result

An initial capacity after initial aging was 2±0.1 Ah. Then, the charge and discharge cycle experiment was performed in a thermostatic chamber of 50° C. A capacity retention ratio (a ratio of the discharge capacity with respect to the initial capacity 2±0.1 Ah) after elapse of 500 cycles was 95±2%. The increasing rate of DC resistance after the charge and discharge experiment at 50° C. was 135±10%.

### EMBODIMENT 10

### Manufacturing of Anode

The anode was manufactured by using a mixture of Si metal powders and graphite as the anode active material in Embodiment 2. An average particle size of the Si metal was 10 μm. In regard to a composition of the anode, a weight ratio of natural graphite, the Si metal, the polymer compound, and the thickening agent was set to 75:20:2:3. A solvent that was used at the time of preparing the anode slurry was set as 1-methyl-2-pyrrolidone to prepare the slurry. The cylindrical lithium ion battery shown in FIG. 1 was manufactured without changing other conditions such as the cathode manufacturing condition.

When manufacturing the anode, other conditions were similar to those in Embodiment 1. Then, evaluation was performed.

### Battery Evaluation Method and Result

An initial capacity after initial aging was 2.2±0.1 Ah. Then, the battery was set in a thermostatic chamber of 50° C., and the cycle experiment was performed under the charge and discharge conditions. After the experiment of 500 cycles was terminated, a battery temperature was returned to room temperature, and the charge and discharge experiment was performed under the same conditions. A capacity retention ratio (a ratio of the discharge capacity with respect to the initial capacity 2.2±0.1 Ah) after elapse of 500 cycles was 88±2%. DC resistance was increased by 190±10% with respect to initial value.

### EMBODIMENT 11

### Manufacturing of Cathode

The cathode was manufactured with the same specifications as Embodiment 1.

### Manufacturing of Anode

The polymer compound in Embodiment 1 was set to [CH₃—(OCH₂CH₂)ₙCO]₂O (in structure I, X is CH₃—, Y is a single bond, R is H, and n is 10 to 100). Specifications such as a method of manufacturing the anode, dimensions, and density were the same as Embodiment 1. That is, the anode was manufactured by using natural graphite having an average particle size of 15 μm as the anode active material, the polymer compound, styrene-butadiene rubber as the binder, and carboxymethyl cellulose as the thickening agent. A weight composition of the natural graphite, the polymer compound, the binder, and the thickening agent was set to 95:2:1.5:1.5. An area of an electrode to which anode slurry was applied was set 500 cm×5.2 cm, and the thickness of the composite material was set to 30 μm.

### Manufacturing Battery

Five cylindrical lithium ion batteries shown in FIG. 1 were manufactured in the same sequence as Embodiment 1.

### Battery Evaluation Method and Result

These batteries were charged with 4.2 V at 0.2 C-rate (a current value is 0.4 A), and then were discharged with a current (2 A) at 1 C-rate to 3.0 V. The capacity of the batteries at this time was 2±0.1 Ah. These batteries were set in a thermostatic chamber of 50° C., and then a cycle experiment was performed under the above-described charge and discharge conditions. After the experiment of 500 cycles was terminated, a battery temperature was returned to room temperature, and the charge and discharge experiment was performed under the same conditions. A capacity retention ratio (a ratio of the discharge capacity with respect to the initial capacity 2±0.1 Ah) after elapse of 500 cycles was 94±1%. DC resistance was increased by 120±10% with respect to an initial value.

### EMBODIMENT 12

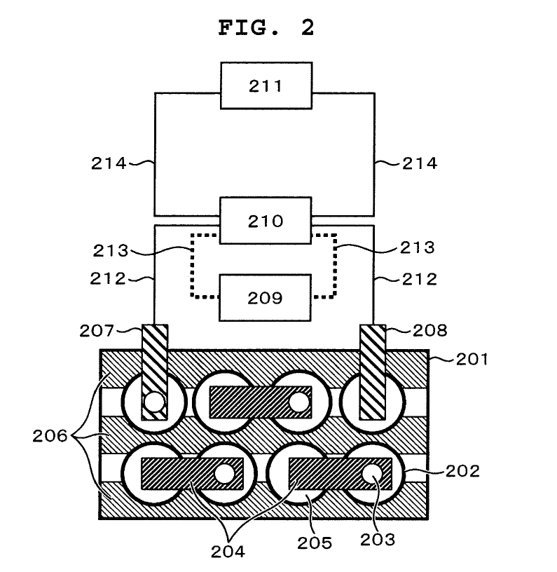

Cylindrical lithium ion batteries 202 having the size of five times the battery shown in FIG. 1 were manufactured by using the anode manufactured in Embodiment 4 and the cathode manufactured in Embodiment 7. A rated capacity was 10 Ah. The cathode terminal 203 and the anode terminal 205 of these batteries 202 were connected by bus bar 204 in series, and a module (battery module) 201 shown in FIG. 2 was assembled with hold component 206. A charge circuit 210, a calculation unit 209, and an external power source 211 are connected to the module 201 using a power line 212, a signal line 213, and an external power cable 214, whereby a configuration shown in FIG. 2 was obtained. The anode was the same as Embodiment 1, and specifications of the cathode were the same as Embodiment 8.

In addition, in these embodiments, the experiment was performed to confirm effectiveness of the invention, such that as an external power source or something to which an external load is attached, the external power source 211 having both functions of power supply and power consumption was used. Even when the external power source 211 is used, there is no difference in an effect of the invention compared to practical use of electric vehicles such as an electric vehicle, machine tools, dispersion type power storage system, or a backup power source system.

In a charging experiment immediately after the assembly of the present system, charging was performed for 1 hour at a constant voltage of 33.6 V by allowing a charge current having a current value (10 A) corresponding to 1 C-rate to flow from the charge circuit 210 to a cathode external terminal 207 and an anode external terminal 208. Here, the constant voltage value is 8 times 4.2 V that is the constant voltage value of the above-described single battery. Power that is necessary for the charge and discharge of the module was supplied from the external power source 211. An ambient temperature was set to 40° C.

In a discharge experiment, a reverse current was made to flow from the cathode external terminal 207 and the anode external terminal 208 to the charge circuit 210, and power was consumed in the external power source 211. The discharge current was set to a condition of 2 C-rate (discharge current was 5 A), and the discharge was performed until an inter-terminal voltage between the cathode external terminal 207 and the anode external terminal 208 reached 24 V. An ambient temperature was set to 40° C.

Under these charge and discharge experiment conditions, an initial performance in which a charge capacity was 10.0 Ah and a discharge capacity was 9.95 to 9.98 Ah was obtained. Furthermore, a charge and discharge cycle experiment of 500 cycles was performed, and a capacity retention ratio of 92±2% was obtained.

### EMBODIMENT 13

### Manufacturing of Cathode

The cathode was manufactured with the same specifications as Embodiment 1.

### Manufacturing of Anode

The graphite powders of Embodiment 1 were subjected to an oxidization process in a nitric acid aqueous solution and a carboxylic group was introduced. Then, the graphite powders were rinsed with water, and CH₃—(OCH₂CH₂)ₙ—OH as the polymer compound was added, and the carboxylic group on the graphite surface and the hydroxyl group of the polymer compound were made to react with each other, whereby the polymer compound was fixed onto the graphite surface (CH₃—(OCH₂CH₂)ₙ—OOC—Z (in structure II, X is CH₃—, Y is a single bond, R is H, and n is 200 to 300). This reaction was expressed in the following formula. The graphite powders were dried in vacuum to remove absorption water, and were used for the anode. When manufacturing the anode, other conditions were similar to those in Embodiment 1. Then, evaluation was performed.

CH₃—(OCH₂CH₂)ₙ—OH+HOOC—Z→CH₃—(OCH₂CH₂)ₙ—OOC—Z

### Battery Evaluation Method and Result

An initial capacity after initial aging was 2±0.1 Ah. Then, the charge and discharge cycle experiment was performed in a thermostatic chamber of 50° C. A capacity retention ratio (a ratio of the discharge capacity with respect to the initial capacity 2±0.1 Ah) after elapse of 500 cycles was 94±2%. The increasing ratio of DC resistance after the charge and discharge experiment at 50° C. was 130±10%.

### EMBODIMENT 14

### Manufacturing of Cathode

The cathode was manufactured with the same specifications as Embodiment 1.

### Manufacturing of Anode

n of the polymer compound in Embodiment 13 was set to 400 to 500 (CH₃—(OCH₂CH₂)ₙ—OOC—Z (in structure II, X is CH₃—, Y is a single bond, R is H, and n is 400 to 500). When manufacturing the anode, other conditions were similar to those in Embodiment 1. Then, evaluation was performed.

### Battery Evaluation Method and Result

An initial capacity of the battery after initial aging was 2±0.1 Ah. Then, the charge and discharge cycle experiment was performed in a thermostatic chamber of 50° C. As a result thereof, a capacity retention rate (a ratio of the discharge capacity with respect to the initial capacity 2±0.1 Ah) after elapse of 500 cycles was 96±1%. The increasing ratio of DC resistance after the charge and discharge experiment at 50° C. was 115±10%.

### EMBODIMENT 15

### Manufacturing of Cathode

The cathode was manufactured with the same specifications as Embodiment 1.

### Manufacturing of Anode

The graphite powders of Embodiment 1 were subjected to an oxidization process in a nitric acid aqueous solution and a carboxylic group was introduced. Then, the graphite powders were rinsed with water, and CH₃—(OCH₂)ₙ—OH as the polymer compound was added, and the carboxylic group on the graphite surface and the hydroxyl group of the polymer compound were made to react with each other, whereby the polymer compound was fixed onto the graphite surface (CH₃—(OCH₂)ₙ—OOC—Z (in structure IV, X is CH₃—, Y is a single bond, R is H, and n is 200 to 300). This reaction was expressed in the following formula. The graphite powders were dried in vacuum to remove absorption water, and were used for the anode. When manufacturing the anode, other conditions were similar to those in Embodiment 1. Then, evaluation was performed.

CH₃—(OCH₂)ₙ—OH+HOOC—Z→CH₃—(OCH₂)ₙ—OOC—Z

### Battery Evaluation Method and Result

An initial capacity of the battery after initial aging was 2±0.1 Ah. Then, the charge and discharge cycle experiment was performed in a thermostatic chamber of 50° C. A capacity retention ratio (a ratio of the discharge capacity with respect to the initial capacity 2±0.1 Ah) after elapse of 500 cycles was 95±1%. The increasing ratio of DC resistance after the charge and discharge experiment at 50° C. was 125±10%.

### EMBODIMENT 16

### Manufacturing of Cathode

The cathode was manufactured with the same specifications as Embodiment 1.

### Manufacturing of Anode

n of the polymer compound in Embodiment 15 was set to 400 to 500 (CH₃—(OCH₂)ₙ—OOC—Z (in structure IV, X is CH₃—, Y is a single bond, R is H, and n is 400 to 500). When manufacturing the anode, other conditions were similar to those in Embodiment 1. Then, evaluation was performed.

### Battery Evaluation Method and Result

An initial capacity after initial aging was 2±0.1 Ah. Then, the charge and discharge cycle experiment was performed in a thermostatic chamber of 50° C. As a result thereof, a capacity retention ratio (a ratio of the discharge capacity with respect to the initial capacity 2±0.1 Ah) after elapse of 500 cycles was 97±1%. The increasing ratio of DC resistance after the charge and discharge experiment at 50° C. was 115±10%.

### COMPARATIVE EXAMPLE 1

### Manufacturing of Anode

The polymer compound in Embodiment 1 was substituted with a binder with the same amount. That is, a weight composition of the natural graphite, the binder, and the thickening agent was set to 95:2.5:2.5. When manufacturing the anode, other conditions were similar to those in Embodiment 1. Then, evaluation was performed.

### Battery Evaluation Method and Result

An initial capacity after initial aging was 2±0.1 Ah. Then, the charge and discharge cycle experiment was performed in a thermostatic chamber of 50° C. A capacity retention ratio (a ratio of the discharge capacity with respect to the initial capacity 2±0.1 Ah) after elapse of 500 cycles was decreased to 82±2%. In addition, DC resistance after elapse of the charge and discharge of 500 cycles was increased by 240% with respect to the initial value. Accompanying the increase in the DC resistance, an output characteristic was decreased compared to Embodiment 1.

### COMPARATIVE EXAMPLE 2

[CH₃—(OCH₂CH₂)ₙ₋₁]OCH₂CH₃, that is, polyether in which the carbonic acid bond portion of the polymer compound in Embodiment 1 was omitted and the distal end was substituted with hydrogen was used, and a battery was manufactured with the same specifications as Embodiment 1 except for the configuration of the polymer compound. This battery was charged with 4.2 V at 0.2 C-rate (a current value is 0.4 A), and then was discharged with a current (2 A) at 1 C-rate to 3.0 V. The capacity of the battery at this time was decreased to 1.6±0.1 Ah. DC resistance after elapse of the charge and discharge of 500 cycles was increased by 300±20% with respect to the initial value. The capacity retention ratio of the charge and discharge cycle experiment was under 65% at the point of time when 50 cycles was elapsed, and thus the battery was disassembled. As a result, it was found that the graphite was dropped out from a partial surface of the anode. The electrolytic solution was extracted and a nuclear magnetic resonance spectrum of the electrolytic solution from which a solvent was evaporated was measured, and it was confirmed that polyether was being dissolved in the electrolytic solution.

TABLE 1

| | | | | | | | Addition | | | |
|---|---|---|---|---|---|---|---|---|---|---|
| | | | | | | | place of | Initial | Capacity | Increasing |
| | | | | | | | polymer | capacity | retention | ratio of DC |
| | Structure | X | R | n | Y | Z | compound | Ah | ratio % | resistance % |
| Embodiment 1 | Structure I | CH₃— | H | 200 to 300 | Single bond | C | Anode | 2 ± 0.1 | 93 ± 2 | 140 ± 10 |
| Embodiment 2 | Structure I | CH₃— | H | 600 to 700 | Single bond | C | Anode | 1.8 ± 0.1 | 93 ± 2 | 120~130 |
| Embodiment 3 | Structure I | CH₃— | H | 200 to 300 | Single bond | C | Anode | 2 ± 0.1 | 91 ± 2 | 160 ± 10 |
| Embodiment 4 | Structure I | CH₃— | H | 10 to 100 | —(CH₂)m— | C | Anode | 2 ± 0.1 | 94 ± 2 | 140 ± 10 |
| Embodiment 5 | Structure III | CH₃— | H | 400 to 500 | Single bond | C | Anode | 2 ± 0.1 | 94 ± 2 | 145 ± 10 |
| Embodiment 6 | Structure III | CH₃— | F | 400 to 500 | Single bond | C | Anode | 2 ± 0.1 | 96 ± 2 | 130 ± 10 |
| Embodiment 7 | Structure I | CH₃— | F | 500 to 600 | Single bond | C | Anode | 2 ± 0.1 | 96 ± 2 | 120 ± 10 |
| Embodiment 8 | Structure III | CH₃— | F | 400 to 500 | Single bond | C | Anode | 2 ± 0.1 | 95 ± 2 | 130 ± 10 |
| Embodiment 9 | Structure III | CH₃— | H | 400 to 500 | Single bond | Ni, Mn, Co | Cathode | 2 ± 0.1 | 95 ± 2 | 135 ± 10 |
| | Structure I | CH₃— | H | 200 to 300 | Single bond | C | Anode | | | |
| Embodiment | Structure I | CH₃— | H | 200 to 300 | Single bond | Si, C | Anode | 2.2 ± 0.1 | 88 ± 2 | 190 ± 10 |
| 10 | | | | | | | | | | |
| Embodiment | Structure I | CH₃— | H | 100 to 200 | Single bond | C | Anode | 2 ± 0.1 | 94 ± 1 | 120 ± 10 |
| 11 | | | | | | | | | | |
| Embodiment | Structure III | CH₃— | H | 400 to 500 | Single bond | C | Anode | 9.95 to | 92 ± 2 | 150 ± 10 |
| 12 | Structure III | CH₃— | H | 400 to 500 | Single bond | Ni, Mn, Co | Cathode | 9.98 | | |
| Embodiment | Structure II | CH₃— | H | 200 to 300 | Single bond | C | Anode | 2 ± 0.1 | 94 ± 2 | 130 ± 10 |
| 13 | | | | | | | | | | |
| Embodiment | Structure II | CH₃— | H | 400 to 500 | Single bond | C | Anode | 2 ± 0.1 | 96 ± 1 | 115 ± 10 |
| 14 | | | | | | | | | | |
| Embodiment | Structure IV | CH₃— | H | 200 to 300 | Single bond | C | Anode | 2 ± 0.1 | 95 ± 1 | 125 ± 10 |
| 15 | | | | | | | | | | |
| Embodiment | Structure IV | CH₃— | H | 400 to 500 | Single bond | C | Anode | 2 ± 0.1 | 97 ± 1 | 115 ± 10 |
| 16 | | | | | | | | | | |
| Comparative | — | — | — | — | — | — | — | 2 ± 0.1 | 82 ± 2 | 240 ± 20 |
| Example 1 | | | | | | | | | | |
| Comparative | Structure I | CH₃— | H | 200 to 300 | H | — | Anode | 1.6 ± 0.1 | <65 | 300 ± 20 |
| Example 2 | | | | | | | | | | |

In Embodiments 1 to 16 in which the polymer compound was used, the DC resistance increasing ratio was lower than Comparative Example 1 in which the polymer compound was not used and Comparative Example 2 in which the polymer compound was not bonded to the active material. In Embodiment 1, and to 16, the capacity retention ratio was higher than Comparative Example 1 and 2, and the DC resistance increasing ratio was lower than Comparative Example 1 and 2. From this result, it can be understood that when the polymer compound is made to bond to the active material, the cycle lifetime and the storage characteristic of the lithium ion battery may be improved.

In regard to the polymer compound having the structure III, Embodiment 5 in which R is hydrogen and Embodiment 6 in which R is fluorine were compared, and it was revealed that the resistance increasing ratio was lower in Embodiment 6. From this result, it can be understood that when halogen is used in the polyether portion, the cycle lifetime and the storage characteristic of the lithium ion secondary battery may be improved.

When comparing Embodiment 15 in which the polyether portion was —(OCR₂)ₙ— and Embodiment 13 in which the polyether portion was —(OCR₂CR₂)ₙ—, the capacity retention ratio was higher in Embodiment 15, and the DC resistance increasing ratio was lower in Embodiment 15. From this result, it was found that it is preferable that an oxygen content ratio in the polyether portion be high from the viewpoints of the capacity retention ratio and the DC resistance.

From the results of Embodiment 2 and Embodiment 11, it was found that when n is 600, the initial capacity is decreased. This is because when the polyether portion is too long, a diffusion path of the lithium ion is increased and thus a supply rate of the lithium ions to the anode active material becomes slow. In addition, from the comparison between Embodiment 1 and Embodiment 11, it can be understood that when n is low, this is effective for improvement of the capacity retention ratio.

Embodiment 3 is an example in which the binder was not used. From the result, it was found that even when the binder is not used, the battery functions as a lithium ion secondary battery, but also the battery has properties superior to Comparative Example 1.

From the result of Embodiment 4, it was found that the introduction of a bond between the polyether portion and the carboxylic acid bond portion is preferable. Particularly, even when Y having a bond length equal to or less than that of the polyether portion was introduced, a high capacity retention ratio was obtained. This is considered because adjacent polymer compounds overlap each other, and thus a lithium ion diffusion route in which the polyether portion is continuous between different polymer compounds is secured.

Embodiment 7 is an example in which a bridge structure was provided to a plurality of polymer compound that were bonded to the active material. When comparing with Embodiment 1, it can be understood that due to the formation of the bridge bond between an acyl bond and an OH bond, the capacity retention ratio was improved. In this embodiment, since the molecules of the polymer compound were connected to each other by the bridge, the strength of the polymer compound layer on the anode was improved. As a result, when comparing with Embodiment 6, it is considered that the resistance increasing ratio of this embodiment is decreased.

Embodiment 8 is an example using a method in which a lithium salt of the polymer compound was added to the electrolytic solution, and the polymer compound was made to bond to the active material. From this embodiment, it was found that as a method of bonding the polymer compound, a method of adding the lithium salt of the polymer compound to the electrolytic solution may be used.

Embodiment 9 is an example in which the polymer compound was used for the cathode active material. The capacity retention ratio (a ratio of the discharge capacity with respect to the initial capacity 2±0.1 Ah) after elapse of 500 cycles was improved to 95±2%, and thus a more excellent lifetime characteristic compared to Embodiment 1 was obtained. In addition, it was found that the initial value of the DC resistance was smaller than 80% of Embodiment 1, and the output characteristic was excellent. In addition, The increasing ratio of DC resistance after the charge and discharge experiment at 50° C. was 135 to 145%, and durability was improved compared a value in Embodiment 4. It is considered that these effects are attributed to an operation in which the polymer compound of the invention is bonded to Ni, Mn, or Co in the cathode active material and thus an oxidization reaction of the electrolytic solution is suppressed.

Embodiment 10 is an example in which Si was mixed as the anode active material. From this result, it can be understood that even when the anode active material is changed to Si, the polymer compound functions. In addition, Si contributes to the high capacity of the anode due to the formation of an alloy with lithium, and the initial capacity is increased compared to the battery of Embodiment 1. From this point, the battery of this embodiment was excellent.

Embodiment 14 is an example in which a polymer compound having the ether bond portion longer than that of Embodiment 13 was used. Since the ether bond portion is long, it is considered that the lithium ions are completely detached from the solvent, and only the lithium ions reach the surface of the anode active material. On the contrary to this, when the ether bond portion is short, it is estimated that a part of the lithium ions that are solvated reach the surface of the anode active material and the solvent is reductively decomposed, and thus a film (Solid-Electrolyte Interface) is easy to grow. This is considered to be caused due to an increase in the DC resistance.

Embodiment 15 is an example using a polymer compound in which the number of oxygen atoms in the polyether portion was the same as the polymer compound in Embodiment 13, but the length there of was shorter than that of Embodiment 13. The polymer compound in Embodiment 15 was apt to have a long lifetime. It is estimated because the distance between oxygen atoms in the polyether portion becomes short, and thus the solvent detachment from the lithium ions is promoted, and the diffusion rate of the lithium ions becomes fast.

Embodiment 16 is an example using a polymer compound in which the ether bond portion was lengthened compared to Embodiment 15. It is considered that due to the extension of the ether bond portion, since the lithium ions are completely detached from the solvent and only the lithium ions reach the surface of the anode active material, the capacity retention ratio is improved and an increase in resistance is suppressed.

The lithium ion secondary battery of the invention is effective for use, particularly, under a high-temperature environment outdoors. For example, power sources for industrial apparatuses such as an electric vehicle, a crewless transfer car, electric construction machinery, and a backup power source, and a battery for energy storage of renewable energy may be exemplified. In addition, in addition to consumer use products such as a portable electronic apparatus, a cellular phone, and an electric tool, the lithium ion secondary battery may be used for power sources of in-door electronic apparatuses such as an electric vacuum cleaner, and care equipment. Furthermore, the lithium ion battery of the invention is applicable to a power source of a logistic train for search of the Moon, the Mars, or the like. In addition, the lithium ion battery of the invention may be used for various kinds of power sources for air conditioning, temperature control, purification of sewage or air, driving power, and the like in a space suit, a space station, a building or a living space (regardless of a closed state or an opened state) on, the earth, or other celestial bodies, a spacecraft for interplanetary movement, a planetary land rover, a closed space in water or sea, a submarine, a fish observing facility, and the like.

1. A coated active material, comprising:
an active material that occludes and emits lithium ions; and
a polymer compound that is bonded to the active material,
wherein the polymer compound is at least of structure I, structure II, structure III, or structure IV
X₁—(OCR₂CR₂)ₙ—Y₁—COO—Z (structure I)
X₁—(OCR₂CR₂)ₙ—Y₁—COO—Z (structure II)
X₂—(OCR₂)ₙ—Y₂—COO—Z (structure III)
X₂—(OCR₂)ₙ—Y₂—COO—Z (structure IV)
X₁ represents any one of hydrogen, a hydrocarbon group having a carbon number of 3 n or less, a halogenated hydrocarbon group having a carbon number of 3 n or less, Z—OOC—Y₁—, and Z—COO—Y₁—,
X₂ represents any one of hydrogen, a hydrocarbon group having a carbon number of 2 n or less, a halogenated hydrocarbon group having a carbon number of 2 n or less, Z—OOC—Y₂—, and Z—COO—Y₂—,
Y₁ represents a hydrocarbon group having a carbon number of 3 n or less, a hydrocarbon group that includes an ester bond and has a carbon number of 3 n or less, or a single bond,
Y2 represents a hydrocarbon group having a carbon number of 2 n or less, a halogenated hydrocarbon group having carbon number of 3 n or less, or a single bond,
R represents either hydrogen or halogen,
Z represents an element that is present on a surface of the active material, and
n is an integer of 1 or more.

2. A lithium ion secondary battery, comprising:
a cathode that is capable of occluding and emitting lithium ions;
an anode that is capable of occluding and emitting the lithium ions,
wherein the cathode includes a cathode composite material,
the anode includes an anode composite material,
the cathode composite material contains a cathode active material,
the anode composite material contains an anode active material, and
the cathode active material or the anode active material is the coated active material according to claim 1.

3. The lithium ion secondary battery according to claim 2,
wherein Z is an element that is capable of being bonded to a carboxylic acid salt.

4. The lithium ion secondary battery according to claim 2,
wherein Z is at least one of C, Si, Sn, Ti, Mn, Fe, Co, or Ni.

5. The lithium ion secondary battery according to claim 2, wherein n is 10 to 500.

6. The lithium ion secondary battery according to claim 2,
wherein a plurality of polymer compounds form a bridge structure with each other.

7. The lithium ion secondary battery according to claim 2,
wherein the anode composite material contains a binder, and
a total weight of the binder and the polymer compound is 1 to 10% by weight based on a total weight of the anode composite material.

8. The lithium ion secondary battery according to claim 2,
wherein the cathode composite material contains a binder, and
a total weight of the binder and the polymer compound is 5 to 20% by weight based on a total weight of the cathode composite material.

9. The lithium ion secondary battery according to claim 2,
wherein a ratio value of the polymer compound with respect to the binder is 0 to 0.75.

10. The lithium ion secondary battery according to claim 2,
wherein the lithium ion secondary battery includes an electrolytic solution, and
decomposition of the electrolytic solution is suppressed by the polymer compound.

11. A method of manufacturing the lithium ion secondary battery according to claim 2, the method comprising:
preparing slurry containing the coated active material and an acid anhydride of the polymer compound; and
causing the coated active material and the acid anhydride to react with each other to form a bond therewith.

12. A method of manufacturing the lithium ion secondary battery according to claim 2, the method comprising:
preparing slurry containing the coated active material, and a salt of the polymer compound in which a carboxylic acid distal end of the polymer compound is set as an alkali metal or alkali earth metal salt; and
forming a bond between the coated active material and the polymer compound.
